(19) United States
(12) Patent Application Publication
(10) Pub. No.: US 2019/0254934 A1
(43) Pub. Date: Aug. 22, 2019

(54) CRAVING BABIES INTELLIGENT PACIFIER

(71) Applicant: Gregory William Lake, Clayton, DE (US)

(72) Inventor: Gregory William Lake, Clayton, DE (US)

(21) Appl. No.: 15/902,502

(22) Filed: Feb. 22, 2018

(51) Int. Cl. A61J 17/00

(52) U.S. Cl. CPC A61J 17/008; A61J 17/006

(57) ABSTRACT

An improved pacifier comprising interchangeable dissolving flavor packets that provide a tasty incentive for babies to use whereby a developing infant determines flavor differences thereby providing flavor variance for a child to recognize, stimulates brain function and encourages further cognitive growth.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pacifier devices and more specifically relates to an improved pacifier comprising interchangeable dissolving flavor packets that provide a tasty incentive for babies to use whereby a developing infant determines flavor differences thereby providing flavor variance for a child to recognize, stimulates brain function and encourages further cognitive growth.

### 2. Description of the Related Art

A pacifier is a rubber, plastic, or silicone nipple given to an infant to suck upon. In its standard appearance it has a teat, mouth shield, and handle. The mouth shield and/or the handle is large enough to avoid the danger of the child choking on it or swallowing it. Babies have a natural tendency to want to suck. Some people tend to over feed their babies to keep them from crying and keep them more content.

Various attempts have been made to solve problems found in pacifier art. Among these are found in: U.S. Pat. No. 20130331888 to Michelle Antinnes; U.S. Pat. No. 5,013,321 to Benjamin F MacVane; and U.S. Pat. No. 20130085475 to Hermon McNac. This prior art is representative of flavored pacifiers.

Ideally, an improved pacifier should be user-friendly and safe in-use and, yet should operate reliably and be manufactured at a modest expense. Thus, a need exists for an improved pacifier comprising interchangeable dissolving flavor packets that provide a tasty incentive for babies to use whereby a developing infant determines flavor differences thereby providing flavor variance for a child to recognize, stimulates brain function and encourages further cognitive growth and to avoid the above-mentioned problems.

### BRIEF SUMMARY OF THE INVENTION

In view of the foregoing disadvantages inherent in the known pacifier device art, the present invention provides an Improved Pacifier (Entitled Craving Babies Intelligent Pacifier). The general purpose of the present invention, which will be described subsequently in greater detail is to provide an improved pacifier comprising interchangeable dissolving flavor packets that provide a tasty incentive for babies to use whereby a developing infant determines flavor differences thereby providing flavor variance for a child to recognize, stimulates brain function and encourages further cognitive growth.

An improved pacifier comprising: a shield member; a handle member; a nipple member including an outer membrane forming an interior volume; and at least one flavor packet. The handle member is attached to an outer side portion of the shield member. Wherein the outer member of the nipple member includes a plurality of perforations therethrough. Wherein the nipple member is releasably attached to an inner side portion of the shield member and is adapted to fit within a mouth of a child.

The at least one flavor packet includes a main material and a chemical additive. Wherein the main material is adapted to dissolve when mixed with saliva. Wherein the chemical additive is adapted to provide a chosen flavor. Wherein the chemical additive is mixed with the main material. Wherein each of the at least one flavor packet is adapted to be removably placed one at a time within said interior volume of the nipple member, such that when mixed with saliva the flavor packet dissolves and flows through the plurality of perforations of the nipple member.

The present invention holds significant improvements and serves as an Improved Pacifier. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Improved Pacifier (Entitled Craving Babies Intelligent Pacifier), constructed and operative according to the teachings of the present invention.

FIG. 1 shows a perspective view illustrating an Improved Pacifier as shown in a retracted condition according to an embodiment of the present invention.

FIG. 2 shows a perspective view illustrating at least one flavor packet of the

Improved Pacifier according to an embodiment of the present invention of FIG. 1.

FIG. 3 is a perspective view illustrating a snap-lock connector of the Improved Pacifier according to an embodiment of the present invention of FIG. 1.

FIG. 4 is a perspective view illustrating a temperature display member, a thermometer member, and a thermometer reset button and of the Improved Pacifier according to an embodiment of the present invention of FIG. 1.

FIG. 5 is a perspective view illustrating a power source including a USB port and a USB power cable of the Improved Pacifier according to an embodiment of the present invention of FIG. 1.

FIG. 6 is a perspective view illustrating a LED charging indicator of the Improved Pacifier according to an embodiment of the present invention of FIG. 1.

FIG. 7 is a perspective view illustrating the Improved Pacifier in an in-use condition according to an embodiment of the present invention of FIG. 1.

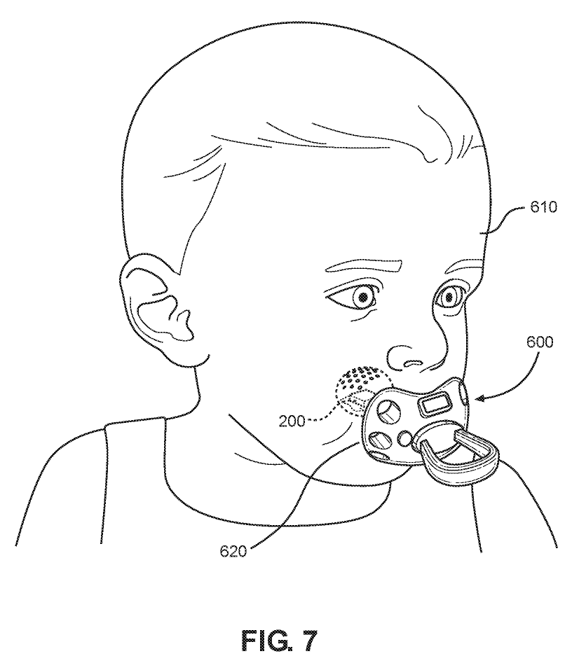

The various embodiments of the present invention will hereinafter be described in conjunction with the appended drawings, wherein like designations denote like elements.

### DETAILED DESCRIPTION

As discussed above, embodiments of the present invention relate to a pacifier device and more specifically relates to an Improved Pacifier (Entitled Craving Babies Intelligent Pacifier). The general purpose of the present invention, which will be described subsequently in greater detail is to provide an improved pacifier comprising interchangeable dissolving flavor packets that provide a tasty incentive for babies to use whereby a developing infant determines flavor differences thereby providing flavor variance for a child to recognize, stimulates brain function and encourages further cognitive growth.

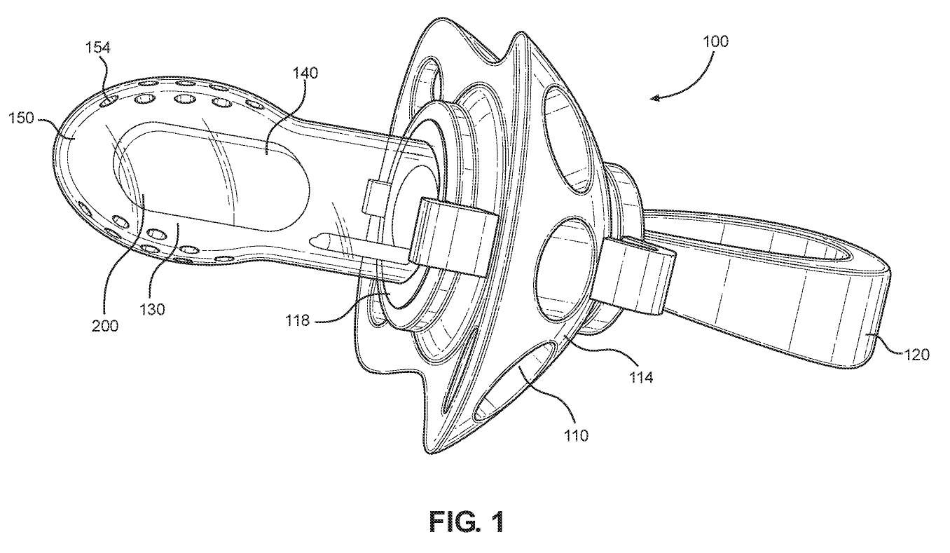

Referring now to FIGS. 1-6, showing perspective views illustrating Improved Pacifier 100 according to an embodiment of the present invention of FIG. 1.

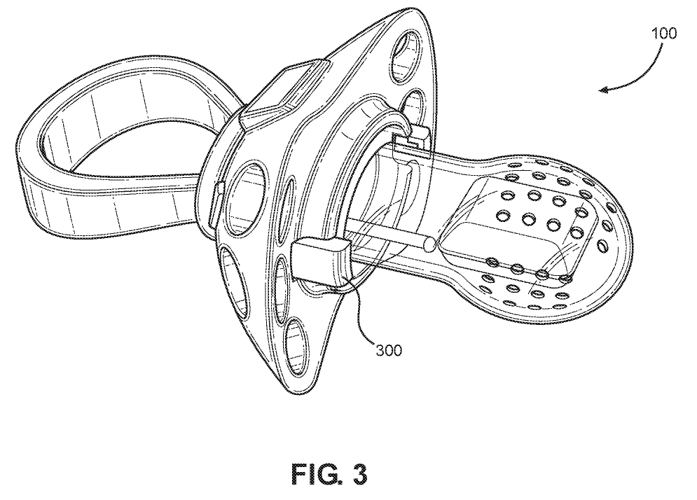

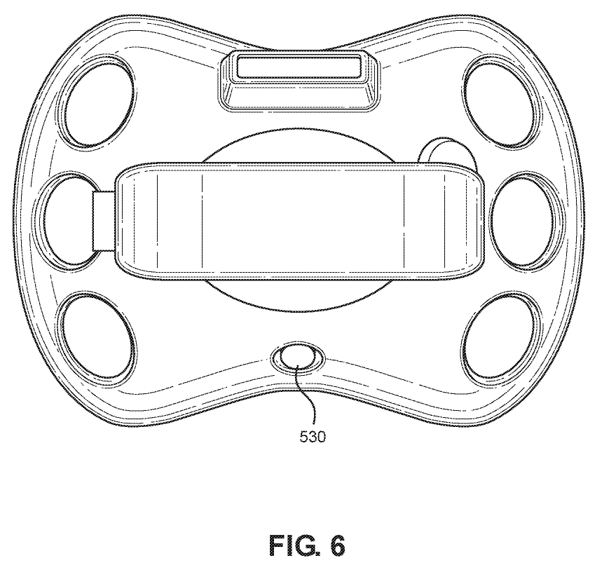

Improved pacifier 100 comprises: shield member 110; handle member 120; nipple member 130 including outer membrane 150 forming interior volume 140; and at least one flavor packet 200. Handle member 120 is attached to outer side portion 114 of shield member 110. Wherein outer membrane 150 of nipple member 130 includes plurality of perforations 154 therethrough. Wherein nipple member 130 is releasably attached to inner side portion 118 of shield member 110 and is adapted to fit within mouth 620 of child 610 as shown in in-use condition 600 of FIG. 6. Wherein nipple member 130 is releasably attached to shield member 110 via a snap-lock connector 300 as shown in FIG. 3. Wherein nipple member 130 is formed from a flexible material. Wherein the flexible material is chosen from a list of materials consisting of latex, silicone, and plastic.

At least one flavor packet 200 includes main material 210 and chemical additive 220. Wherein main material 210 is adapted to dissolve when mixed with saliva. Wherein chemical additive 220 is adapted to provide a chosen flavor. Wherein chemical additive 220 is mixed with main material 210. Wherein each at least one flavor packet 200 is adapted to be removably placed one at a time within interior volume 140 of nipple member 130, such that when mixed with saliva flavor packet 200 dissolves and flows through plurality of perforations 154 of nipple member 130.

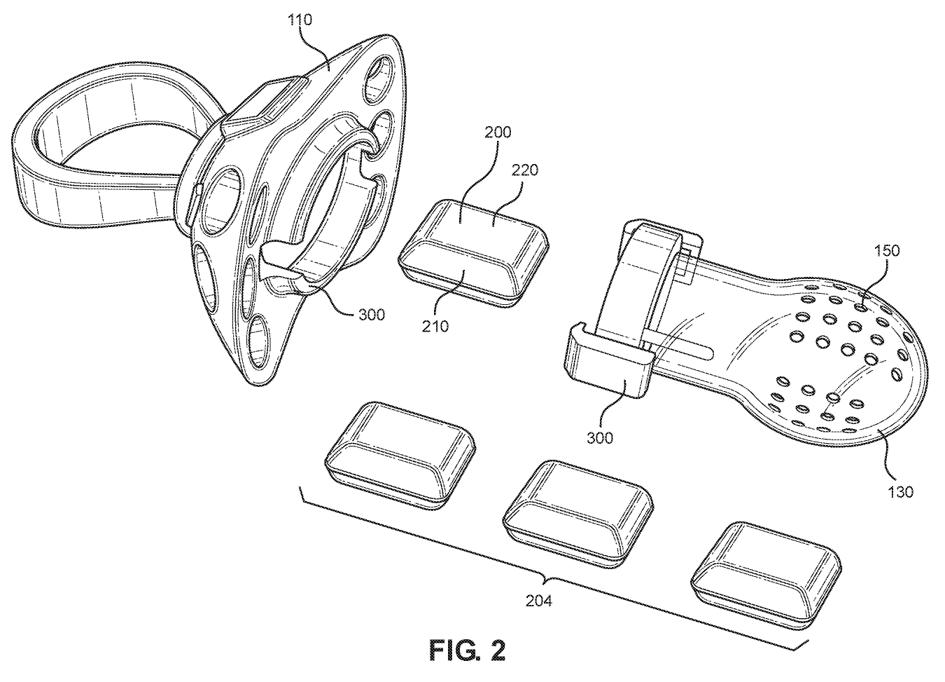

Pacifier 100 further comprises plurality of flavor packets 204, wherein each of plurality of flavor packets 204 includes a different chemical additive from the other flavor packets to thereby provide a variety of different flavors, such that said flavor packets can be removably interchanged depending on a choice of a particular flavor as shown in FIG. 2.

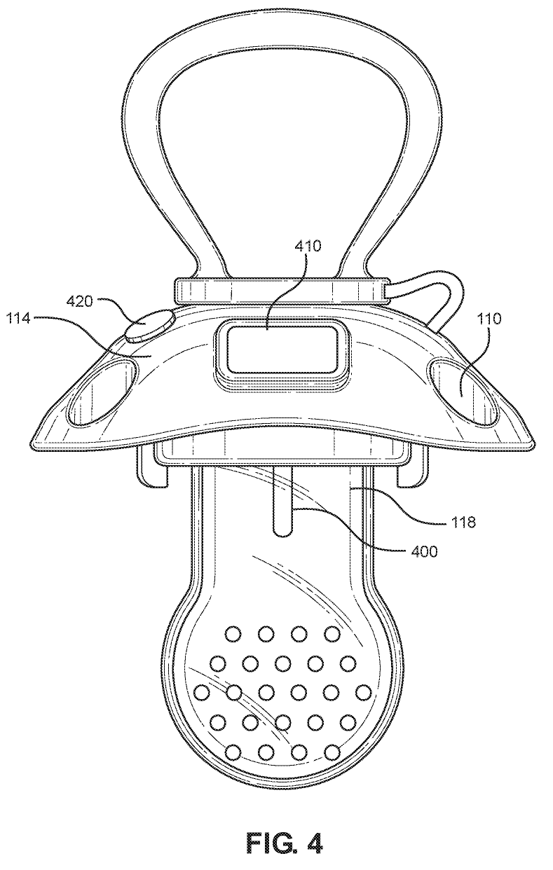

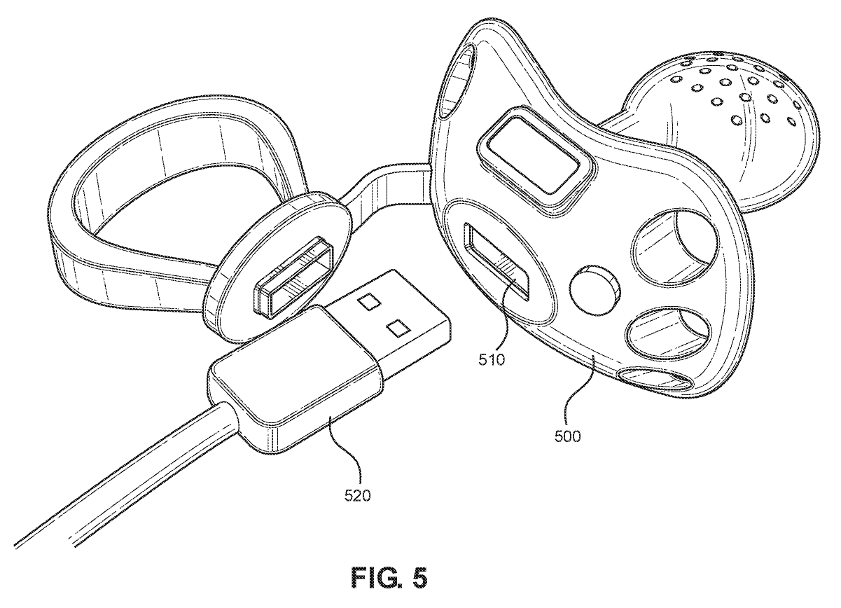

Pacifier 100 further comprising thermometer member 400 attached to inner side portion 118 of shield member 110 and extends therefrom, and adapted to extend into nipple member 130 and measure the temperature of saliva within nipple member 130. Pacifier 100 further comprising temperature display member 410 attached to outer side portion 114 of shield member 110, is electronically connected to thermometer member 400, and is adapted to display the temperature of saliva within nipple member 130. Pacifier 100 further comprising power source 500 located within interior volume 140 of shield member 110 and is electronically connected to and adapted to provide power to thermometer member 400 and temperature display member 410. Pacifier 100, further comprising thermometer reset button 420 attached to said outer side portion 114 of shield member 110, is electronically connected to thermometer member 400, and is adapted to reset thermometer member 400 for a new temperature reading as shown in FIG. 4.

Wherein power source 500 includes USB port 510 and USB power cable 520 removably attachable to USB port 510 as shown in FIG. 5A. Wherein handle member 120 is releasably attached to shield member 110 via USB port 510, such that when handle 120 is removed it exposes USB port 510 for attachment to USB power cable 520. Pacifier 100 further comprising LED charging indicator 530 attached to outer side portion 118 of shield member 110, is electronically connected to power source 500, and is adapted to indicate when power source 500 is being recharged.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved pacifier comprising:
a shield member;
a handle member;
wherein said handle member is attached to an outer side portion of said shield member;
a nipple member including:
an outer membrane forming an interior volume;
wherein said outer membrane includes a plurality of perforations therethrough;
wherein said nipple member is releasably attached to an inner side portion of said shield member and is adapted to fit within a mouth of a child;
at least one flavor packet including:
a main material;
wherein said main material is adapted to dissolve when mixed with saliva; and
a chemical additive;
wherein said chemical additive is adapted to provide a chosen flavor;
wherein said chemical additive is mixed with said main material;
wherein each said at least one flavor packet is adapted to be removably placed one at a time within said interior volume of said nipple member, such that when mixed with saliva said flavor packet dissolves and flows through said plurality of perforations of said nipple member.

2. The pacifier of claim 1, further comprising a plurality of flavor packets, wherein each of said plurality of flavor packets includes a different chemical additive from the other flavor packets to thereby provide a variety of different flavors, such that said flavor packets can be removably interchanged depending on a choice of a particular flavor.

3. The pacifier of claim 1, wherein said nipple member is releasably attached to said shield member via a snap-lock connector.

4. The pacifier of claim 1, further comprising a thermometer member attached to said inner side portion of said shield member and extends therefrom, and adapted to extend into said nipple member and measure the temperature of saliva within said nipple member.

5. The pacifier of claim 4, further comprising a temperature display member attached to said outer side portion of said shield member, is electronically connected to said thermometer member, and is adapted to display the temperature of saliva within said nipple member.

6. The pacifier of claim 5, further comprising a power source located within an interior volume of said shield member and is electronically connected to and adapted to provide power to said thermometer member and said temperature display member.

7. The pacifier of claim 6, wherein said power source includes a USB port and a USB power cable removably attachable to said USB port.

8. The pacifier of claim 5, further comprising a thermometer reset button attached to said outer side portion of said shield member, is electronically connected to said thermometer member, and is adapted to reset said thermometer for a new temperature reading.

9. The pacifier of claim 6, further comprising a LED charging indicator attached to said outer side portion of said shield member, is electronically connected to said power source, and is adapted to indicate when said power source is being recharged.

10. The pacifier of claim 1, wherein said nipple member is formed from a flexible material.

11. The pacifier of claim 1, wherein said flexible material is chosen from a list of materials consisting of latex, silicone, and plastic.

12. The pacifier of claim 7, wherein said handle member is releasably attached to said shield member via said USB port, such that when said handle is removed it exposes said USB port for attachment to said USB power cable.
